(19) United States
(12) Patent Application Publication
(10) Pub. No.: US 2015/0106187 A1
(43) Pub. Date: Apr. 16, 2015

(54) SYSTEM AND METHOD FOR INCENTING RFID TRANSACTION DEVICE USAGE AT A MERCHANT LOCATION

(71) Applicant: III HOLDINGS 1, LLC, Wilmington, DE (US)

(72) Inventors: Michael J. Berardi, Lauderhill, FL (US); Michal Bliman, Matawan, NJ (US); David S. Bonalle, New Rochelle, NY (US); Jennifer Anne Elwood, Okemos, MI (US); Matthew C. Hood, Wayne, PA (US); Susan E. Isenberg, London (GB); Trevor J. Perry, West Jordan, UT (US); Peter D. Saunders, Salt Lake City, UT (US); Kristin L. VonWald, Phoenix, AZ (US)

(21) Appl. No.: 14/580,050

(22) Filed: Dec. 22, 2014

Related U.S. Application Data
(63) Continuation of application No. 10/907,602, filed on Apr. 7, 2005.
Application No. 10/907,602 is a continuation-in-part of application No. 10/340,352, filed on Jan. 10, 2003, now Pat. No. 7,889,052.
Application No. 10/907,602 is a continuation-in-part of application No. 10/192,488, filed on Jul. 9, 2002, now Pat. No. 7,239,226.
(60) Provisional application No. 60/396,577, filed on Jul. 16, 2002.
(60) Provisional application No. 60/304,216, filed on Jul. 10, 2001.

(51) Int. Cl. G06Q 30/02; G06Q 20/34

(52) U.S. Cl. CPC G06Q 30/0226; G06Q 20/352
USPC 705/14.27

(57) ABSTRACT

A system and method for providing incentives at a merchant location for using a RF identification (RFID) transaction device for transaction completion is provided. An RFID transaction device account number includes a marker for identifying that the transaction is being completed using an RFID transaction device. A merchant system recognizes the marker and provides incentives to the RFID device user accordingly. In one embodiment, the incentives are provided to an RFID device user in real-time. Alternatively, the merchant system may provide the incentives to the customer at a later time. Further still, incentives may be provided to the user based on a prior transaction history, user profile, or any other data related to the user, user account, merchant, product or service.

### CROSS-REFERENCE TO RELATED APPLICATIONS

This application is a continuation-in-part of and claims priority to U.S. patent application Ser. No. 10/340,352, entitled “SYSTEM AND METHOD FOR INCENTING PAYMENT USING RADIO FREQUENCY IDENTIFICATION IN CONTACT AND CONTACTLESS TRANSACTIONS,” filed Jan. 10, 2003 (which itself claims priority to U.S. Provisional Patent Application No. 60/396,577, filed Jul. 16, 2002). This application is also a continuation-in-part and claims priority to U.S. patent application Ser. No. 10/192,488, entitled “SYSTEM AND METHOD FOR PAYMENT USING RADIO FREQUENCY IDENTIFICATION IN CONTACT AND CONTACTLESS TRANSACTIONS,” filed on Jul. 9, 2002 (which itself claims priority to U.S. Provisional Patent Application No. 60/304,216, filed Jul. 10, 2001). All of the above-listed applications are incorporated herein by reference.

### FIELD OF INVENTION

This invention generally relates to a system and method for a Radio Frequency (RF) transaction using a RF operable transaction device, and more particularly, to incenting usage of a Radio Frequency Identification (RFID) device for transaction completion.

### BACKGROUND OF INVENTION

Merchants are consistently looking for ways to increase repeat business from their customers. One method that is used is to provide the customer with incentives, such as, coupons or rebates designed to entice the customer to revisit a merchant location and purchase the merchant's products or services. Traditionally, these incentives are provided to the customer in the form of paper coupons often mailed to the customer or provided to the customer at the merchant location. In some instances, the incentives may be provided to the customer electronically, for example, via the Internet. In yet another example, merchants provide incentives to customers who enroll in a merchant managed customer loyalty program. Of significance is the proliferation of Radio Frequency Identification (RFID) technology, which is compelling merchants to seek new ways to integrate the RFID technology and incentive programs to increase the number of recurrent customers.

Like barcode and voice data entry, RFID is a contactless information acquisition technology. RFID systems are wireless, and are usually extremely effective in hostile environments where conventional acquisition methods fail. RFID has established itself in a wide range of markets, such as, for example, the high-speed reading of railway containers, tracking moving objects such as livestock or automobiles, and retail inventory applications. As such, RFID technology has become a primary focus in automated data collection, identification and analysis systems worldwide.

Of late, companies are increasingly embodying RFID data acquisition technology in portable devices presentable by hand. For example, RFID modules are being placed in a key chain fob or tag for use in completing financial transactions. A typical RFID module includes a RF transponder and is ordinarily a self-contained device housed on a portable form factor. In some instances, a battery may be included with the RFID module to power the transponder and attendant internal circuitry of the RFID module. Alternatively, the RFID module may not have a battery or other independent internal power source. In this instance the internal circuitry of the RFID module (including the transponder) may gain its operating power directly from a RF interrogation signal provided by, for example, a RF reader. U.S. Pat. No. 5,053,774, issued to Schuermann, describes a typical transponder RF interrogation system which may be found in the prior art. The Schuermann patent describes in general the powering technology surrounding conventional transponder structures. U.S. Pat. No. 4,739,328 discusses a method by which a conventional transponder may respond to a RF interrogation signal. Other typical modulation techniques which may be used include, for example, ISO/IEC 14443 and the like.

In the conventional RFID module powering technologies used, the RFID module is typically activated upon presenting the RFID module in a RF field generated by an interrogation signal. In some cases when the RFID module is placed in the RF field, the RFID module is typically activated irrespective of whether the user desires such activation. These are called “passive” RFID devices. Alternatively, an “active” RFID device is one having an internal power source to power the RFID module internal circuitry.

One of the more visible uses of the RFID technology is found in the introduction of Exxon/Mobil's Speedpass® and Shell's EasyPay® products. These products use transponders placed in a fob or tag which enables automatic identification of the user when the fob is presented at a Point-of-Sale (POS) device. Fob identification data is typically passed to a third-party server database, where the identification data is referenced to a customer (e.g., user) credit or debit account. In an exemplary processing method, the server seeks authorization for the transaction by passing the transaction and account data to an authorizing entity, such as for example an “acquirer” or account issuer. Once the server receives authorization from the authorizing entity, the authorizing entity sends clearance to the point-of-sale device for completion of the transaction.

However, existing RFID device systems such as Speedpass® and EasyPay® do not usually permit means for automatically incenting the use of the RFID device associated with the system as opposed to the credit or charge card associated with a transaction account shared by the card and the RFID device.

Consequently, a need exists for an RFID device system which is capable of determining when an RFID device is used, and providing an incentive for such usage.

### SUMMARY OF INVENTION

The present invention includes a system and method for incenting an RFID device transaction that addresses the above-identified shortcomings found in conventional RFID device transaction methods. In one exemplary embodiment of the present invention, a system is provided which incents usage of an RFID device at the merchant location. The merchant system distinguishes between the instance where a transaction is initiated using an RFID device as opposed to using a charge or credit card sharing the same funding source as the RFID device. Where the RFID device is used, the system may provide incentives to the RFID device user based on criteria predetermined by the merchant. If the RFID device user is enrolled in a merchant loyalty program the invention may provide reward points based on the criteria associated with the RFID device usage. Further, the system according to this invention may incent an RFID device user based on parameters associated to the transaction.

These features and other advantages of the system and method, as well as the structure and operation of various exemplary embodiments of the system and method, are described below.

### BRIEF DESCRIPTION OF THE DRAWINGS

The accompanying drawings, wherein like numerals depict like elements, illustrate exemplary embodiments of the present invention, and together with the description, serve to explain the principles of the invention. In the drawings:

FIG. 1 illustrates an exemplary RFID-based system depicting exemplary components for use in RFID transaction completion in accordance with the present invention;

FIG. 2 illustrates an exemplary method for incenting an RFID device user at the merchant location; and

FIG. 3 illustrates an exemplary screen shot utilized in an embodiment of the present invention.

### DETAILED DESCRIPTION

The present invention may be described herein in terms of functional block components, screen shots, optional selections and various processing steps. Such functional blocks may be realized by any number of hardware and/or software components configured to perform to specified functions. For example, the present invention may employ various integrated circuit components (e.g., memory elements, processing elements, logic elements, look-up tables, and the like), which may carry out a variety of functions under the control of one or more microprocessors or other control devices. Similarly, the software elements of the present invention may be implemented with any programming or scripting language such as C, C++, Java, COBOL, assembler, PERL, extensible markup language (XML), JavaCard and MULTOS with the various algorithms being implemented with any combination of data structures, objects, processes, routines or other programming elements. Further, it should be noted that the present invention may employ any number of conventional techniques for data transmission, signaling, data processing, network control, and the like. For a basic introduction on cryptography, review a text written by Bruce Schneier entitled “Applied Cryptography: Protocols, Algorithms, and Source Code in C,” published by John Wiley & Sons (second edition, 1996), herein incorporated by reference.

In addition, many applications of the present invention could be formulated. The exemplary network disclosed herein may include any system for exchanging data or transacting business, such as the Internet, an intranet, an extranet, WAN, LAN, satellite communications, and/or the like. It is noted that the network may be implemented as other types of networks, such as an interactive television network (ITN).

Further still, the terms “Internet” or “network” may refer to the Internet, any replacement, competitor or successor to the Internet, or any public or private inter-network, intranet or extranet that is based upon open or proprietary protocols. Specific information related to the protocols, standards, and application software utilized in connection with the Internet may not be discussed herein. For further information regarding such details, see, for example, Dilip Naik, Internet Standards and Protocols (1998); Java 2 Complete, various authors, (Sybex 1999); Deborah Ray and Eric Ray, Mastering HTML 4.0 (1997); Loshin, TCP/IP Clearly Explained (1997). All of these texts are hereby incorporated by reference.

The term “communication” may refer to a signal that travels to/from one component to another. The components may be directly connected to each other or may be connected through one or more other devices or components. The various coupling components for the devices can include but are not limited to the Internet, a wireless network, a conventional wire cable, an optical cable or connection through air, water, or any other medium that conducts signals, and any other coupling device or medium. A variety of conventional communications media and protocols may be used for data links between components. For example, the data links may be an Internet Service Provider (ISP) configured to facilitate communications over a local loop as is typically used in connection with standard modem communication, cable modem, dish networks, ISDN, Digital Subscriber Lines (DSL), or any wireless communication media. In addition, a merchant system according to this invention includes a POS device and host network. The merchant system may reside on a local area network which interfaces to a remote network for remote authorization of an intended transaction. The merchant system may communicate with the remote network via a leased line, such as a T1, D3 line, or the like. Such communications lines are described in a variety of texts, such as, “Understanding Data Communications,” by Gilbert Held, which is incorporated herein by reference.

Where required, the system user may interact with the system via any input device such as, a keypad, keyboard, mouse, kiosk, personal digital assistant, handheld computer (e.g., Palm Pilot®, Blueberry®), cellular phone and/or the like). Similarly, the invention could be used in conjunction with any type of personal computer, network computer, work station, minicomputer, mainframe, or the like running any operating system such as any version of Windows, Windows NT, Windows 2000, Windows 98, Windows 95, MacOS, OS/2, BeOS, Linux, UNIX, Solaris or the like. Moreover, although the invention may frequently be described as being implemented with TCP/IP communications protocol, it should be understood that the invention could also be implemented using SNA, IPX, Appletalk, IPte, NetBIOS, OSI or any number of communications protocols. Moreover, the system contemplates the use, sale, or distribution of any goods, services or information over any network having similar functionality described herein.

An RFID transaction device identifier, as used herein, may include an identifier for a transaction device which may be correlated to a user transaction account (e.g., credit, charge debit, checking, savings, reward, loyalty, or the like) maintained by a transaction account provider (e.g., payment authorization center). A typical transaction account identifier (e.g., account number) may be correlated to a credit or debit account, loyalty account, or rewards account maintained and serviced by such entities as American Express, Visa and/or MasterCard, or the like.

To facilitate understanding, the present invention may be described with respect to a loyalty account. However, it should be noted that the invention is not so limited and other accounts permitting an exchange of goods and services for an account data value is contemplated to be within the scope of the present invention. In that regard, the transaction device identifier discussed herein may be, for example, a sixteen-digit credit card number, although each credit provider has its own numbering system, such as the fifteen-digit numbering system used by American Express. Each company's credit card numbers comply with that company's standardized format such that the company using a sixteen-digit format will generally use four spaced sets of numbers, as represented by the number “0000 0000 0000 0000”. In a typical example, the first five to seven digits are reserved for processing purposes and identify the issuing bank, card type and, etc. In this example, the last sixteenth digit is used as a sum check for the sixteen-digit number. The intermediary eight-to-ten digits are used to uniquely identify the customer. The account number stored as Track 1 and Track 2 data as defined in ISO/IEC 7813, and further may be made unique to RFID transaction device.

In one exemplary embodiment, the transaction device identifier may include a unique RFID transaction device serial number and user identification number, as well as specific application applets. In another embodiment, the transaction device identifier may include a marker that facilitates recognition of the transaction device identifier as originating with an RFID device. The transaction device identifier may be stored on a transaction device database located on transaction device. Additionally, the RFID device may include a transaction device database configured to store multiple account numbers issued to RFID transaction device user by the same or different account providing institutions. In addition, where the transaction device identifier corresponds to a loyalty or rewards account, a merchant system database may be configured to store the attendant loyalty or rewards points data in associated relationship with the RFID transaction device identifier.

The RFID transaction device identifier is stored in distinct data locations on the merchant system database. In some instances an RFID device transaction history information may be stored on the merchant system database relative to the RFID transaction device identifier. The merchant system may use the transaction history information, and any other parameters as determined by the merchant, to determine which incentives to use.

Databases discussed herein may be a graphical, hierarchical, relational, object-oriented or other database, and may be maintained on a local drive of a server or on a separate computer coupled to the server via a local area or other network (not shown). In one embodiment, databases disclosed are a collection of ASCII or other text files stored on a local drive of server. Database information is suitably retrieved from the database and provided to transaction processing systems upon request via a server application, as described more fully below.

In addition to the above, transaction device identifier may be associated with any secondary form of identification configured to allow the consumer to interact or communicate with a payment system. For example, transaction device identifier may be associated with, an authorization/access code, personal identification number (PIN), Internet code, digital certificate, biometric data, and/or other secondary identification data used to verify a transaction device user identity.

It should be noted that conventional components of RFID transaction devices may not be discussed herein for brevity. For instance, one skilled in the art will appreciate that RFID transaction device and RFID reader disclosed herein include traditional transponders, antennas, protocol sequence controllers, modulators/demodulators and the like, necessary for proper RFID data transmission. As such, those components are contemplated to be included in the scope of the invention.

It should be further noted that the transfer of information in accordance with this invention, may be done in a format recognizable by a merchant system or account issuer. In that regard, by way of example, the information may be transmitted in magnetic stripe or multi-track magnetic stripe format. Because of the proliferation of devices using magnetic stripe format, the standards for coding information in magnetic stripe format were standardized by the International Standards Organization (ISO).

Typically, magnetic stripe information is formatted in three tracks. Certain industry information must be maintained on certain portion of the tracks, while other portions of the tracks may have open data fields. The contents of each track and the formatting of the information provided to each track is controlled by ISO standard ISO/IEC 7811. For example, the information must typically be encoded in binary. Track 1 is usually encoded with user information (name) in alphanumeric format. Track 2 is typically comprised of discretionary and nondiscretionary data fields. In one example, the nondiscretionary field may comprise 19 characters and the discretionary field may comprise 13 characters. Track 3 is typically reserved for financial transactions and includes enciphered versions of the user's personal identification number, country code, currently units amount authorized per cycle, subsidiary accounts, and restrictions.

As such, where information is provided in accordance with this invention, it may be provided in magnetic stripe format track. For example, counter values, authentication tags and encrypted identifiers, described herein, may be forwarded encoded in all or a portion of a data stream representing data encoded in, for example, track 2 or track 3 format.

Further still, various components may be described herein in terms of their “validity.” In this context, a “valid” component is one which is authorized for use in completing a transaction request in accordance with the present invention. Contrarily, an “invalid” component is one which is not authorized for transaction completion. In addition, an invalid component may be one which is not recognized as being permitted for use on the secure RF system described herein.

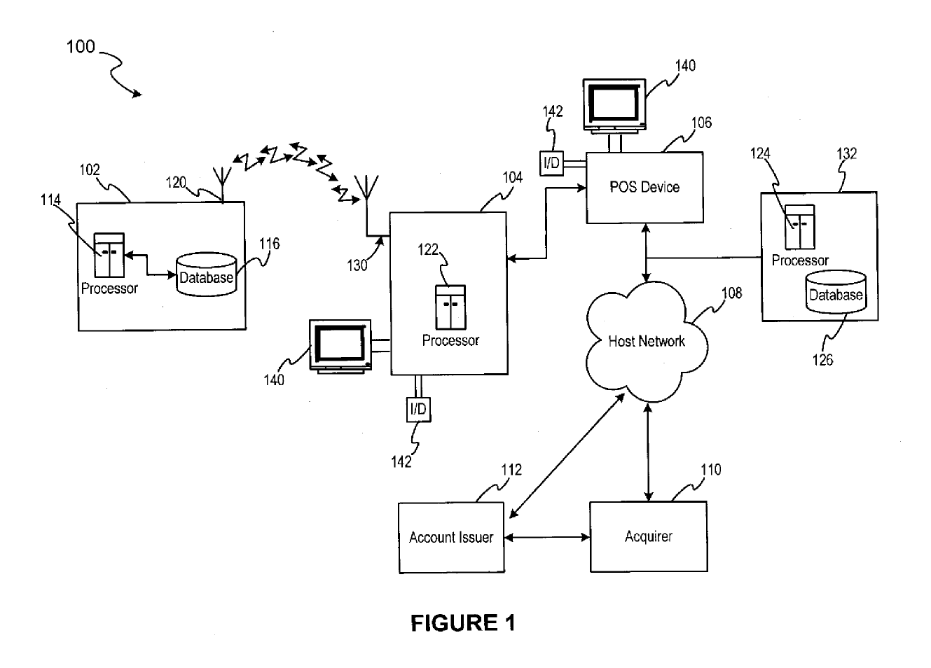

FIG. 1 illustrates an exemplary secure RFID transaction system 100 in accordance with the present invention. In general, system 100 may include an RFID transaction device 102 in RF communication with an RFID reader 104 for transmitting data there between. RFID reader 104 may be in further communication with a merchant point-of-sale (POS) device 106 for providing to POS 106 data received from RFID transaction device 102. POS 106 may be in further communication with a merchant system 132 for receiving data from the RFID transaction device and providing incentives. Merchant system 132 is in further communication with an acquirer 110 or an account issuer 112 via host network 108. Merchant system 132 transmits a transaction request to acquirer 110 or account issuer 112. The transaction request would include information received from RFID reader 104. Acquirer 110 or account issuer 112 may provide merchant system 132 with an authorization for transaction completion.

Although the point-of-interaction (POI) device is described with respect to a merchant point-of-sale (POS) device, the invention is not to be so limited. Indeed, a merchant POS device is used by way of example. Thus, the point-of-interaction device may be any device capable of receiving transaction device 102 account data. In this regard, the POS may be any point-of-interaction device enabling the user to complete a transaction using a transaction device 102. POS device 106 may receive RFID transaction device 102 information and provide the information to merchant system 132 for processing.

As used herein, an “acquirer” may be a third-party entity including various databases and processors for facilitating the routing of the transaction request to an appropriate account issuer 112. Acquirer 110 may route the request to account issuer in accordance with a routing number provided by RFID transaction device 102. The “routing number” in this context may be a unique network address or any similar device for locating an account issuer 112 on host network 108. Traditional means of routing the payment request in accordance with the routing number are well understood. As such, the process for using a routing number to provide the payment request will not be discussed herein for brevity.

Additionally, account issuer (“account provider” or “issuer system”) 112 may be any entity which provides a transaction account for facilitating completion of a transaction request. The transaction account may be any credit, debit, loyalty, direct debit, checking or savings account, or the like. The term “issuer” or “account provider” may refer to any entity facilitating payment of a transaction using a transaction device, and which includes systems permitting payment using at least one of a preloaded and non-preloaded transaction device. Typical issuers may be American Express, MasterCard, Visa, Discover, and the like. In the preloaded value processing context, an exchange value (e.g., money, rewards points, barter points, etc.) may be stored in a preloaded value database (not shown) for use in completing a requested transaction. The preloaded value database and thus the exchange value may not be stored on transaction device itself, but may be stored remotely, such as, for example, at account issuer 112 location. Further, the preloaded value database may be debited the amount of the transaction requiring the value to be replenished. The preloaded value may be any conventional value (e.g., monetary, currency units, rewards points, barter points, etc.) which may be exchanged for goods or services. In that regard, the preloaded value may have any configuration as determined by issuer system 112.

In general, during operation of secure system 100, RFID reader 104 may provide an interrogation signal via antenna 130 to transaction device 102 for powering device 102 and receiving transaction device 102 related data. The interrogation signal may be received at a transaction device antenna 120 and may be further provided to a transponder (not shown). In response, a transaction device processor 114 may retrieve a transaction device identifier from a transaction device database 116 for providing to RFID reader 104. RFID reader processor 122 is provided a transaction device identifier and processes it to complete a transaction request. Typically, transaction device identifier may be encrypted prior to providing the transaction device identifier to a modulator/demodulator (not shown) for providing the identifier to RFID reader 104.

RFID reader 104 and RFID transaction device 102 may engage in mutual authentication prior to transferring any transaction device 102 data to RFID reader 104. For a detailed explanation of a suitable mutual authentication process for use with the present invention, please refer to commonly-owned U.S. patent application Ser. No. 10/340,352, entitled “SYSTEM AND METHOD FOR INCENTING PAYMENT USING RADIO FREQUENCY IDENTIFICATION IN CONTACT AND CONTACTLESS TRANSACTIONS,” filed Jan. 10, 2003, incorporated by reference in its entirety.

The merchant may wish to provide a customer an incentive based on the customer using an RFID device to complete a transaction for the merchant's goods or services. For example, merchant system 132 may recognize that transaction device 102 is an RFID device (sometimes called “RFID transaction device 102” herein) being used to complete a transaction, in which case merchant system 132 may award points (e.g., loyalty points) to one or more awards accounts linked to RFID transaction device 102 user. In one embodiment, merchant system 132 may maintain the awards account on a merchant system database 126. Merchant system 132 may award the loyalty points based on any criteria as determined by merchant system 132. Exemplary criteria may include awarding points or incentives for frequency of RFID transaction device 102 usage, amount of individual purchase using RFID transaction device 102, total amount of purchases in a given time period, geographical location of merchant system 106, type of merchant, type of product or service purchased, or any such criteria for incenting RFID transaction device 102 usage. The points (e.g., loyalty points) may be stored in a points or awards account maintained on merchant system 126 database. The awards points may then later be redeemed from the rewards account in exchange for goods and services as desired by the RFID transaction device 102 user. For example, the RFID transaction device 102 user may redeem the award points by accepting offers provided by the merchant during a transaction as described more fully below.

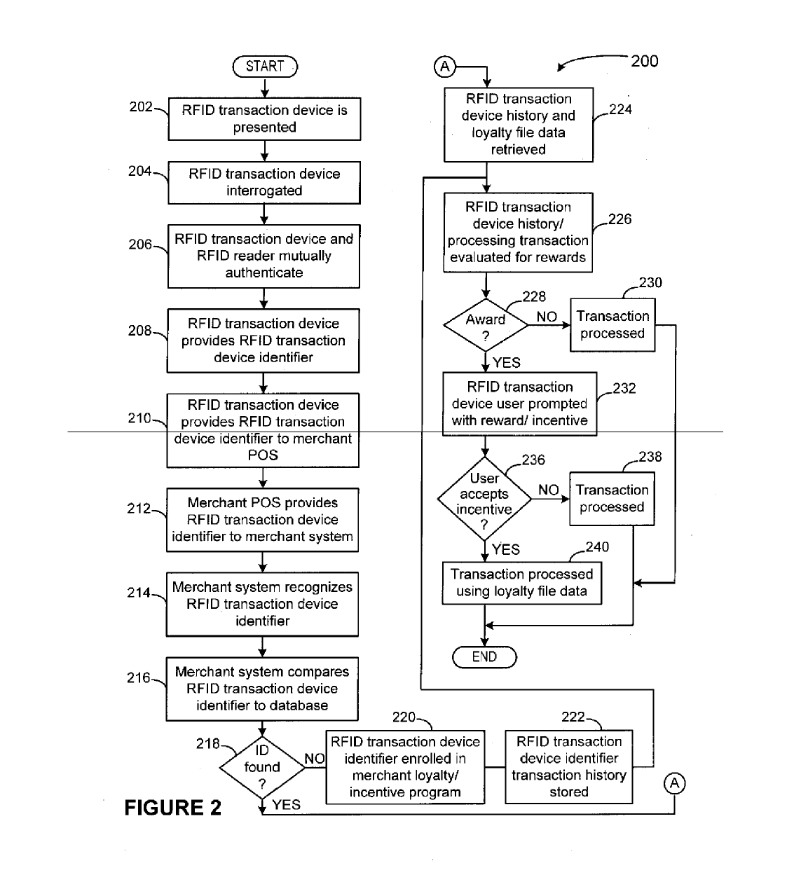

FIG. 2 depicts an exemplary method 200 for awarding loyalty points according to an embodiment of the present invention. An RFID transaction device 102 user uses an RFID transaction device 102 to complete a transaction at a merchant system 132. In general, merchant system 132 recognizes that an RFID transaction device 102 is being used to complete the transaction and provides the user with incentives such as, for example, loyalty reward points, rebates, discounts, coupons or the like. Method 200 is best understood with reference to FIG. 1.

A user presents an RFID transaction device 102 for transaction completion (step 202). In initiating the transaction, the user may place RFID transaction device 102 in the interrogation field cast by RFID reader 104 (step 204). Upon interrogation, RFID transaction device 102 and RFID reader 104 may engage in “mutual authentication” (step 206). That is, RFID transaction device 102 may receive authenticating data from RFID reader 104 and validate or verify that RFID reader 104 is authorized to receive RFID transaction device 102 account information. Similarly, RFID reader 104 may receive authenticating data from RFID transaction device 102 and validate or verify that RFID transaction device 102 is authorized to transmit account information for transaction completion. For detailed description of an exemplary mutual authentication process that may be used with the invention, please refer to commonly-owned U.S. patent application Ser. No. 10/192,488, entitled, “SYSTEM AND METHOD FOR PAYMENT USING RADIO FREQUENCY IDENTIFICATION IN CONTACT AND CONTACTLESS TRANSACTION,” incorporated herein by reference.

Upon successful mutual authentication, RFID transaction device 102 provides an RFID transaction account number to RFID reader 104 via RF communication (step 208). In one exemplary embodiment, RFID transaction device processor 114 retrieves the account number from RFID transaction device database 116. Processor 114 may then provide the transaction account number to RFID reader 104 via appropriate transponders and modulator (not shown) and RFID transaction device antenna 120. RFID reader 104 may receive the transaction device account number and provide the account number to merchant POS 106 (step 210), which in turn, provides the transaction device account number to merchant system 132 (step 212). For brevity, the operation of interrogating an RFID transaction device 102 and receiving a transaction device account number is not discussed in detail. For a detailed understanding of an exemplary operation of steps 202-212 refer to the previously-cited U.S. patent application Ser. No. 10/192,488.

Merchant system 132 may receive the transaction device account number (and any “transaction request” data related to the transaction request, such as, geographical location of merchant, product/service identifier, quantity of items requested, etc.) and recognize that the transaction account number is being provided by RFID transaction device 102 (step 214). For example, the transaction account number may include a maker, or other identifier which identifies the transaction account number as being associated with RFID transaction device 102. The marker may be operable to indicate to merchant system 132 that a particular RFID transaction device 102 is being used to complete a transaction. Alternatively, the marker may be assigned to a particular class, such as, for example, the class of all transaction account numbers provided by RFID transaction device 102.

The marker may be a number which is included as a portion of the transaction account number by transaction account issuer 112. Account issuer 112 may include the marker in the transaction account number when account issuer 112 populates the transaction account number on RFID transaction device database 116 using any conventional RFID transaction device personalization process. In another exemplary embodiment, the marker may be appended to a portion of the RFID transaction account number by merchant system 132. Merchant system 132 may receive the transaction account number from merchant POS 106 and assign the transaction account number a marker for use in identifying the transaction account number as being provided by RFID transaction device 102 or RFID reader 104. In another embodiment, merchant POS 106 may receive the transaction account number from RFID reader 104 and append the marker to the transaction account number prior to providing the transaction account number to merchant system 132.

Merchant system 132 may receive the transaction account number at merchant processor 124. Merchant processor 124 may receive the transaction account number and recognize that the number includes a marker identifying the transaction number as corresponding to RFID transaction device 102. For example, merchant processor 124 may subject the transaction account number to an algorithm designed to identify whether a marker exists. If the marker exists, merchant system processor 124 may compare the transaction account number to the plurality of RFID transaction account numbers stored on merchant database 126 (step 216). In this context, merchant database 126 is configured to store the RFID transaction account number, transaction history at merchant database 126 in a transactions account number data file that is associated with the RFID transaction account number, and, in a loyalty reward file, the loyalty rewards awarded to the RFID transaction device 102 account user. Each of the aforementioned data may be stored on merchant database 126 in distinct database locations correlative to each individual RFID transaction account number. Merchant system 132 may receive an RFID transaction account number from RFID transaction device 102, and merchant processor 124 may compare the received RFID transaction account number to those previously stored on merchant database 126 (step 218).

If a match does not exist (step 218), then merchant system 132 may enroll the RFID transaction account number in a merchant system loyalty program or other program for use in identifying an RFID transaction account number and providing incentives (step 220). In enrolling the RFID transaction account number, merchant system 132 may create a distinct file location on merchant database 126 for storing the RFID transaction account number and any other data related to the particular transaction (step 222). The merchant may store the data in the distinct file location and record that the data is related to a particular RFID transaction number. In this way, merchant system 132 may track the transaction history related to each RFID transaction device 102 account number for use in offering rewards and incentives, as described more fully below. Merchant system 132 may then offer the user an incentive (step 228).

If a match exists (e.g., a corresponding RFID transaction account number exists on merchant database 126), then merchant system processor 124 locates the corresponding matching transaction account number, transaction history and loyalty reward file from database 126 (step 224). Merchant system processor 124 retrieves the noted corresponding data and processes the transaction request data. For example, merchant system processor 124 may retrieve the corresponding data and evaluate the corresponding data and the transaction request data under merchant predetermined criteria for determining whether to offer or provide the RFID transaction device 102 user with loyalty points or incentives (step 226). The merchant predetermined criteria may be stored on merchant database 126 in the form of a rules protocol which may govern the operation of merchant processor 124 to evaluate the transaction requested and/or the transaction history related to the RFID transaction account number.

If no loyalty award or incentive is to be provided to the RFID transaction device 102 user based on the results of the evaluation (step 228), then merchant system 132 may process the transaction under its defined “business as usual” standards (step 230). Alternatively, if merchant system 132 is to provide loyalty awards or incentives to an RFID transaction device 102 user based on the results of the evaluation (step 228), then merchant system 132 may notify the RFID transaction device 102 user of the available loyalty/incentive (step 232). Merchant system processor 124 may update the file location on merchant database 126 with the loyalty/incentive information corresponding to RFID transaction device 102.

Merchant system 132 may visually, audibly or tactilely notify the user of the incentive or reward. In one exemplary notification method, POS 106 or RFID reader 104 may include a display 140 for visually indicating the availability of the incentive or loyalty award to the user. Display 140 may be any conventional screen operable to display messages readable to the casual observer. Merchant system 132 may also facilitate notifying the user in other ways, such as email, pager, cell phone, etc. POS 106 or RFID reader 104 may additionally include an input apparatus for receiving responses from the user.

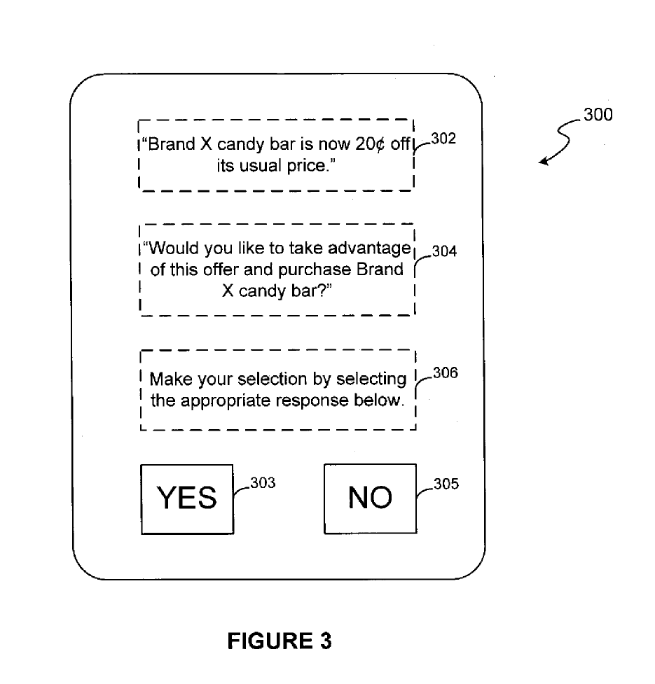

FIG. 3 depicts an exemplary screenshot 300 which may be provided to the user. Screenshot 300 is stored in merchant database 126 and is provided to the user in response to the evaluation noted in step 228. Processor 124 retrieves screenshot 300 and provides screenshot 300 to display 140.

In the example shown, via prompt 302, the user is encouraged to purchase an impulse item such as “Brand X” candy bar. In this instance, an “impulse item” is one which is often placed near the location where the transaction completion is initiated or completed. For example, the typical shopper will understand that in an ordinary grocery store impulse items are typically found on end caps near the cash register, POS 106, RFID reader 104 or the like.

Once the RFID transaction device 102 user is notified of the incentive, via display 300, merchant system 132 may prompt the user to indicate whether the incentive is accepted. Prompt 304 asks the user to indicate whether the user “would like to take advantage” of the incentive. Display 300 may include different instructional prompts (e.g., prompt 306) providing the user instructions on completing a transaction. In one exemplary embodiment, prompt 306 may require the user to accept or reject an incentive by selecting from a “YES” indicator 303 and a “NO” indicator 305 if display 300 is a touch screen. The user may make his selection by touching “YES” indicator 303 or “NO” indicator 305 using a stylus, the user's hand, or any other selection device or method (step 236). In another exemplary embodiment, system 100 may include an input apparatus 142, for receiving RFID transaction device 102 user input. For example, POS 106 or RFID reader 104 may include an input apparatus 142 for communicating with merchant system 132. In this example, input apparatus 142 includes “YES” indicator 303 and “NO” indicator 305. “YES” indicator 303 and “NO” indicator 305 may be push buttons, pressure or heat sensitive buttons, or the like.

If the user rejects the incentive, the user may select “NO” indicator 305 and the transaction may be processed under “business as usual” standards within merchant system 132 (step 238). Otherwise, the user accepts the incentive by selecting “YES” indicator 303 and the transaction is processed in accordance with the description of the incentive (step 240). For example, the user may accept the incentive given by prompt 302 by selecting “YES” indicator 303, and providing a Brand X candy bar to a merchant to process with the user's pending transaction.

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. In addition, the steps recited in any of the method or process claims may be executed in any order and are not limited to the order presented. Further, the present invention may be practiced using one or more servers, as necessary. Thus, the preceding detailed description is presented for purposes of illustration only and not of limitation, and the scope of the invention is defined by the preceding description, and with respect to the attached claims.

1-8. (canceled)

9. A method, comprising:
receiving, by a remote server, transaction information indicating that a transaction has been initiated using a transaction device;
the remote server determining that the transaction device is configured to conduct transactions via a wireless interface of the transaction device; and
based on the transaction device being configured to conduct transactions via the wireless interface, the remote server causing crediting of an amount of loyalty points to a loyalty account associated with the transaction device.

10. The method of claim 9, further comprising:
determining, by the remote server, transaction history associated with an account corresponding to the transaction device, wherein the transaction history is indicative of a total amount of transactions over a predetermined time interval; and
the remote server calculating the amount of loyalty points credited based on the transaction history.

11. The method of claim 9, further comprising:
based on a serial number configured to be stored on a storage location of the transaction device, the remote server determining that the transaction device is configured to conduct transactions via the wireless interface of the transaction device.

12. The method of claim 9, wherein the transaction device is one of a credit card, a debit card, a pre-paid card, a charge card, a smart card, or a gift card.

13. The method of claim 9, wherein the transaction device includes at least one radio-frequency identification transponder configured to facilitate the transaction via the wireless interface.

14. The method of claim 9, wherein the transaction device is configured to receive power from an external source, and wherein the wireless interface is configured to use the received power to initiate the transaction.

15. The method of claim 9, wherein the wireless interface of the transaction device includes a wireless transponder configured to communicate with a point-of-sale device that is included in a communication network associated with the remote server.

16. The method of claim 9, wherein the wireless interface of the transaction device includes an antenna configured to respond to a signal from a radio-frequency identification reader that is included in a communication network associated with the remote server.

17. A non-transitory computer readable medium having instructions stored thereon that are executable by a computer system to cause the computer system to perform operations comprising:
detecting a request to purchase at least one item using a financial instrument;
determining that the financial instrument is configured to facilitate purchasing the at least one item via a wireless interface of the financial instrument; and
based on determining that the financial instrument is configured to facilitate purchasing the at least one item via the wireless interface of the financial instrument, crediting rewards points to at least one rewards account associated with the financial instrument.

18. The non-transitory computer readable medium of claim 17, wherein the operations further comprise:
comparing an account number corresponding to the financial instrument to account numbers that have been enrolled in a rewards program; and
based on the comparing, determining the at least one rewards account associated with the financial instrument.

19. The non-transitory computer readable medium of claim 17, wherein the operations further comprise transmitting to another computer device information that facilitates a display of a balance of the at least one rewards account.

20. The non-transitory computer readable medium of claim 17, wherein the operations further comprise:
determining that a marker is included in an account number associated with the financial instrument, wherein the marker is indicative of the financial instrument being configured to facilitate purchasing the at least one item; and
based on determining that the marker is included in the account number, calculating the rewards points credited.

21. The non-transitory computer readable medium of claim 17, wherein the operations further comprise:
determining a particular category associated with the at least one item, wherein the at least one item is a product or a service; and
based on the particular category, calculating the rewards points credited.

22. A method, comprising:
receiving, by a computer device, a request to use a financial instrument as a form of payment for a transaction;
determining, by the computer device, that the financial instrument is usable as the form of payment via a wireless interface of the financial instrument; and
based on the financial instrument being usable as the form of payment via the wireless interface of the financial instrument, the computer device causing a transmission of an incentive to a consumer corresponding to the financial instrument.

23. The method of claim 22, further comprising:
based on a portion of an account number corresponding to the financial instrument, the computer device determining an identifier identifying the financial instrument being usable as the form of payment via the wireless interface of the financial instrument.

24. The method of claim 22, further comprising:
the computer device receiving from a point-of-sale device an encrypted account number corresponding to the financial instrument; and
based on the encrypted account number being decrypted, the computer device determining that the financial instrument is usable as the form of payment via the wireless interface of the financial instrument.

25. The method of claim 22, further comprising:
the computer device comparing an account number corresponding to the financial instrument to one or more other account numbers, wherein the one or more other account numbers correspond to one or more other financial instruments that have been previously used as forms of payments via respective wireless interfaces of the one or more other financial instruments; and
based on the comparing, the computer device determining that the financial instrument is usable as the form of payment via the wireless interface of the financial instrument.

26. The method of claim 22, wherein the incentive is determined based on information indicating a frequency of the financial instrument being used as the form of payment via the wireless interface of the financial instrument.

27. The method of claim 22, wherein the transmission of the incentive includes information indicative of an offer of exchanging an item for a portion of a balance in a rewards account associated with the financial instrument.

28. The method of claim 22, wherein the incentive includes a discount, a rebate, a promotion, a reward, a prize, a bonus, a gift, or a coupon.
